(19) United States
(12) Patent Application Publication
(10) Pub. No.: US 2026/0278332 A1
(43) Pub. Date: Sep. 17, 2026

(54) METHOD AND SYSTEM FOR HYPERGRAPH NEURAL NETWORK INFERENCE

(71) Applicant: HUAZHONG UNIVERSITY OF SCIENCE AND TECHNOLOGY, Wuhan (CN)

(72) Inventors: Yu ZHANG, Wuhan (CN); Yingqi ZHAO, Wuhan (CN); Jin ZHAO, Wuhan (CN); Hui YU, Wuhan (CN); Xiaofei LIAO, Wuhan (CN); Hai JIN, Wuhan (CN)

(21) Appl. No.: 19/329,969

(22) Filed: Sep. 16, 2025

(30) Foreign Application Priority Data
Mar. 14, 2025 (CN) 202510306199.9

(51) Int. Cl. G06N 3/042

(52) U.S. Cl. CPC G06N 3/042

(57) ABSTRACT

A method and system for hypergraph neural network inference are provided, wherein the method includes: extracting topological information of vertices with the highest degree from a compressed hypergraph topological representation, identifying common high-degree vertices and their connected hyperedges, and transmitting them to a task queue; based on common vertices from the task queue and a common vertex table, triggering hyperedge aggregation operations on each hyperedge in parallel; temporarily storing intermediate aggregation results in an intermediate result buffer of an on-chip cache unit after the aggregation, and reusing the intermediate results of the common vertices during sequential execution based on a hyperedge storage order, thereby obtaining a final aggregation result for each hyperedge. This approach enables compact execution of computing tasks and improves inference efficiency by reducing unnecessary memory access and communication through cache reuse.

### BACKGROUND OF THE APPLICATION

### 1. Technical Field

The present disclosure generally relates to the field of graph computing, and more particularly to a method and system for hypergraph neural network inference.

### 2. Description of Related Art

A hypergraph neural network (HGNN) is an extension of a common graph neural network (GNN), designed to process data structures with complex high-order relationships. By utilizing a hypergraph as input, the HGNN learns vertex representations through information propagation along hyperedges. This approach significantly improves the modeling capability for complex relationships and dependencies, and has been widely applied in domains such as product recommendation and social network analysis.

However, existing techniques have certain limitations. First, due to the power-law distribution of hypergraphs, most computations involve a small number of common vertices with the highest degree and hyperedges, resulting in repeated access and processing of their features, thereby incurring redundant computational overhead. Second, when a hyperedge comprises many vertices, the hyperedge aggregation operation requires frequent retrieval of their feature data from off-chip memory. This frequent retrieval increases memory access operations, reduces computation efficiency, constrains the entire process by memory bandwidth, and introduces substantial irregular memory access issues.

In addition, redundant computation and irregular memory access reduce the effective utilization of cache and memory bandwidth, adversely affecting the overall performance of the hypergraph neural network. Although various software- and hardware-based approaches have been proposed to accelerate the HGNN inference, existing solutions typically compute each vertex and hyperedge independently, without fully considering the overlapping characteristics among hyperedges from a global hypergraph perspective. Such overlap is particularly evident in hyperedges with many vertices and frequently computed. Consequently, features of common vertices are redundantly computed across different computational contexts, intensifying memory access overhead and computational redundancy.

As described above, although hypergraph neural networks exhibit strong capabilities in modeling complex relationships and dependencies, their computational efficiency remains constrained by the aforementioned factors, especially when processing large-scale or high-complexity datasets, where these issues become increasingly prominent.

CN117391166A discloses a hypergraph neural network updating method based on redundancy elimination. The method determines vertices and hyperedges in the hypergraph neural network, combines vertices into pairs to identify vertex pairs, and determines overlapping hyperedges for each pair to construct a redundancy aggregation set. Non-updated hyperedges are updated, and non-aggregated hyperedges in the set are aggregated. Updated and aggregated hyperedge features are stored in a cache. Vertex features are then updated according to the updated hyperedge features corresponding to the vertices and/or the aggregated features of the redundancy aggregation set, yielding an updated hypergraph neural network. This approach reduces redundant computation on repeated hyperedges by using a pre-determined redundancy aggregation set and caching the updated and aggregated hyperedge features, thereby achieving more efficient updates. However, constructing the redundancy aggregation set requires enumerating all vertex pairs (vᵢ, vⱼ) and checking shared hyperedges. For a hypergraph with n vertices, the number of vertex pairs is O(n²). For each pair, the shared hyperedge set is checked; with m hyperedges, each containing an average of d vertices, the intersection's time complexity is O(m·d). In large-scale hypergraphs, computational and storage demands grow exponentially, yet most redundancy aggregation sets are small, offering limited benefits relative to overhead. In contrast, the present disclosure focuses on vertices with the highest degree, which account for the largest proportion of redundant computation, minimizing storage and management overhead. Moreover, unlike the common sequence of updating hyperedges before vertices, the present disclosure explores the potential for parallel updates of vertices and hyperedges in hypergraph neural networks.

Note that, due to potential discrepancies in understanding among persons skilled in the art, and the extensive literature and patents reviewed by the applicant during development, not all details are listed due to space constraints. This does not imply that the present disclosure lacks existing art features; rather, it encompasses all relevant existing art features. The applicant reserves the right to supplement the background with further details and features from related existing art, as appropriate, in accordance with relevant regulations.

### SUMMARY OF THE APPLICATION

Existing technologies in hypergraph neural network inference have some shortcomings. First, due to the power-law distribution of hypergraphs, most computations involve a small subset of common vertices and hyperedges, leading to repeated access and processing of their features and resulting in redundant computational overhead. Second, when processing hyperedges that comprise many vertices, the hyperedge aggregation operation frequently retrieves vertex features from off-chip memory. This frequent access increases memory access operations, reduces computation efficiency, constrains the overall process by memory bandwidth, and introduces substantial irregular memory access issues.

To address the shortcomings of existing technologies, the present disclosure provides a method for hypergraph neural network inference, wherein the method comprises: extracting topological information of vertices with the highest degree from a compressed hypergraph topological representation; identifying common vertices with the highest degree and their connected hyperedges, and transmitting them to a task queue; triggering hyperedge aggregation operations in parallel based on common vertices from the task queue and a common vertex table; performing the hyperedge aggregation operation for each hyperedge, temporarily storing hyperedge aggregation intermediate results (also referred to as intermediate aggregation results) in an intermediate result buffer of an on-chip cache unit, and, during sequential execution of the hyperedge aggregation operations based on the storage order of hyperedges in the hypergraph topology, reusing the intermediate aggregation results of the common vertices from the common vertex table, thereby obtaining a final aggregation result for each hyperedge.

The method of the present disclosure significantly reduces unnecessary computation, memory access, and off-chip communication overhead by adopting a topology-driven data loading strategy (extracting vertices with the highest degree and their associated information) and a redundancy-aware asynchronous aggregation execution method (reusing intermediate results in hyperedge aggregation results of common vertices). This design effectively improves the throughput of hypergraph neural network inference and achieves faster inference speed.

According to a preferred embodiment, the step of extracting topological information of vertices with the highest degree comprises: reading a compressed hypergraph topological representation; extracting root vertices, vertex offsets, hyperedges, hyperedge offsets, and neighboring vertices; and forming a data item comprising four fields: vertex ID, starting and ending offsets within the vertex offsets, and an ID array of the neighboring vertices.

This step facilitates efficient data organization and caching, thereby reducing off-chip memory access operations, maximizing resource utilization of the processor, and minimizing the overhead associated with redundant data transfers.

According to a preferred embodiment, the step of identifying common vertices with the highest degree and their connected hyperedges comprises: extracting root vertices, neighboring vertices, and neighboring vertex offsets; detecting the degree of each neighboring vertex of the root vertices; traversing a neighboring vertex degree list; if an empty entry is encountered, performing an assignment operation; if a non-empty entry is encountered, comparing the degree of the current vertex with the field of that entry; if the current vertex's degree is greater, treating the entry as empty and performing the assignment operation; if the degree is less, continuing the traversal, thereby identifying vertices with higher degrees than previously known and recording them in the common vertex table.

By employing an optimized traversal and comparison mechanism, this step ensures fast identification and recording of common vertices with the highest degree in the common vertex table, and provides a foundation for subsequent hyperedge aggregation operation to reduce redundant computation and further enhance the inference speed of the hypergraph neural network.

According to a preferred embodiment, the step of identifying common vertices with the highest degree and their connected hyperedges further comprises: acquiring in real time an updated entry index of the common vertex table, retrieving that entry, and extracting the corresponding vertex ID, its associated vertex features, and hyperedge features; assembling the vertex ID, vertex features, and hyperedge features into a task entry, and transmitting the task entry to the task queue. This step fully leverages the computational capacity of the processor, avoiding idle time caused by waiting for data loading, thereby improving computation efficiency and resource utilization of the processor.

According to a preferred embodiment, the method further comprises: transmitting partial aggregation results of hyperedges and vertices to a data synchronization unit to obtain final features of each vertex; simultaneously storing the intermediate aggregation results of hyperedges, corresponding hyperedge IDs, and the number of participating vertices in an intermediate result buffer to ensure subsequent reduction operations are triggered at the appropriate time. This step employs an efficient data synchronization mechanism and an intermediate result buffering strategy to reduce data transfer latency and optimize the triggering of reduction operations. This approach eliminates unnecessary memory access and communication overhead, thereby enhancing the overall inference efficiency of the hypergraph neural network and further accelerating inference speed.

The present disclosure further provides a hypergraph neural network inference system comprising a data loading unit, a task dispatch unit, a hypergraph computation unit, and an on-chip cache unit. The data loading unit is configured to extract topological information of vertices with the highest degree from a compressed hypergraph topological representation; identify common vertices with the highest degree and their connected hyperedges, and transmit them to the task dispatch unit in the form of a task queue. The task dispatch unit is configured to dispatch tasks to the hypergraph computation unit in response to task dispatch instructions issued by a control unit. The hypergraph computation unit is configured to trigger hyperedge aggregation operations in parallel based on common vertices from the task queue and a common vertex table, perform the hyperedge aggregation operation for each hyperedge, temporarily store intermediate aggregation results in an intermediate result buffer of the on-chip cache unit, and, during sequential execution of the hyperedge aggregation operations based on the storage order of hyperedges in the hypergraph topology, reuse the intermediate aggregation results of the common vertices from the common vertex table, thereby obtaining a final aggregation result for each hyperedge. The on-chip cache unit is configured to cache data generated by the hypergraph computation unit during the aggregation process.

By incorporating an on-chip cache unit to store intermediate aggregation results generated during hyperedge aggregation, the system of the present disclosure significantly reduces access to external memory and mitigates memory access latency. Furthermore, through the coordinated operation of the task dispatch unit and the hypergraph computation unit, efficient parallel processing and reuse of intermediate aggregation results are achieved. This design conforms to the principles of a multi-level caching architecture, maximizes data reuse, and enhances overall system performance.

According to a preferred embodiment, the interaction between the data loading unit and the on-chip cache unit comprises: accessing cached features, and retrieving input features from off-chip memory in response to a cache miss on a required feature; when loading vertex features from off-chip memory, the data loading unit evaluates whether the total degree of the vertex meets a threshold TD; if the condition is met, the vertex features are cached to a vertex feature buffer, reducing off-chip access operations through a dynamic caching strategy; when the vertex feature buffer has insufficient space, the data loading unit evicts vertex features with a total degree equal to the current threshold TD until sufficient space is freed for new vertex features; the threshold TD is updated based on the total degree of the most recently cached vertex.

By evaluating the total degree of each vertex and applying a cache eviction strategy, the system can prioritize the retention of frequently accessed data within limited cache space, thereby reducing unnecessary data transfers and memory access overhead. This approach resembles cache locality optimization in hardware accelerators, effectively alleviating data access bottlenecks and improving data retrieval efficiency.

According to a preferred embodiment, the step of the data loading unit identifying common vertices with the highest degree and their connected hyperedges comprises: extracting root vertices, neighboring vertices, and neighboring vertex offsets; detecting the degree of each neighboring vertex of the root vertices; traversing a neighboring vertex degree list; if an empty entry is encountered, performing an assignment operation; if a non-empty entry is encountered, comparing the degree of the current vertex with the field of that entry; if the current vertex's degree is greater, treating the entry as empty and performing the assignment operation; if the degree is less, continuing the traversal, thereby identifying vertices with higher degrees than previously known and recording them in the common vertex table.

This process within the data loading unit provides critical input for subsequent hyperedge aggregation, thereby reducing redundant computation and unnecessary data processing. The optimized algorithm design enables the system to significantly accelerate hypergraph neural network inference and enhance overall throughput.

According to a preferred embodiment, the hypergraph computation unit comprises an update processing module and an aggregation processing module. The update processing module performs feature mapping and vertex update operations based on row-wise matrix multiplication; the aggregation processing module performs aggregation operations, including hyperedge aggregation and vertex aggregation.

With this architecture, the system achieves full utilization of computational resources in the processor and minimizes idleness. Additionally, the feature mapping method based on row-wise matrix multiplication further improves computational efficiency and ensures high utilization of the processor.

According to a preferred embodiment, the system further comprises a data synchronization unit configured to perform reduction operations and activation function operations, wherein the data synchronization unit comprises a partial-result collection element and a reduction element. The partial-result collection element is configured to record partial results of aggregation operations, and to track corresponding hyperedge IDs or vertex IDs, as well as the number of vertices or hyperedges involved in each partial aggregation. The reduction element is configured to perform the reduction operation when it is detected that the number of vertices that have completed the hyperedge aggregation operation equals the degree of the corresponding hyperedge, thereby indicating that all partial results from the vertices have been collected.

By precisely tracking the number of vertices that have completed the hyperedge aggregation operation and triggering reduction operations only when specific conditions are met, the data synchronization unit avoids unnecessary redundant computation and data transfers, thereby significantly reducing overhead. The data synchronization unit further enhances the parallel computing capability of the system. By decoupling the collection of partial results from the final reduction operation, the system enables the hyperedge aggregation operation to be executed in parallel across multiple hyperedges or vertices, without waiting for all related tasks to complete. This approach not only improves computational efficiency but also enhances the scalability of the system, allowing it to better support large-scale hypergraph neural network inference tasks.

### BRIEF DESCRIPTION OF THE DRAWINGS

FIG. 1 is an architectural diagram of a hypergraph neural network inference system according to the present disclosure;

FIG. 2 is a schematic flowchart of the operation of a data loading unit according to the present disclosure;

FIG. 3 is a schematic flowchart of an aggregation computation method according to the present disclosure;

FIG. 4 is an architectural diagram of a data loading unit according to the present disclosure;

FIG. 5 is an architectural diagram of a hypergraph computation unit according to the present disclosure;

FIG. 6 is an architectural diagram of a data synchronization unit according to the present disclosure; and

FIG. 7 illustrates a compressed sparse row (CSR) representation of a hypergraph according to the present disclosure.

### DETAILED DESCRIPTION OF THE APPLICATION

The present disclosure is described in detail below with reference to the accompanying drawings.

Certain terms used in this disclosure are defined as follows.

Hardware accelerator: A hardware component specifically designed to accelerate particular computational tasks. Compared to general-purpose CPUs, hardware accelerators have higher efficiency in handling specialized workloads such as graphics rendering, encryption/decryption, or deep learning. By offloading complex or highly repetitive tasks, they enhance system performance and reduce power consumption. Common forms of hardware accelerators include GPUs, FPGAs, and ASICs. These components are extensively used in fields such as machine learning, data compression, and cryptography, significantly improving efficiency, speed, and energy efficiency.

On-chip cache unit: A high-speed storage region specifically designed to improve data access speed.

Hypergraph: A mathematical structure as an extension of the common graph structure. In a hypergraph, a single hyperedge can connect an arbitrary number of vertices, rather than being limited to two. Formally, a hypergraph H is defined as an ordered pair H=(X, E), where X is a vertex set and E is a hyperedge set formed by non-empty subsets of the vertex set X. This structure enables the modeling of multi-way relationships among entities and is particularly suitable for applications involving complex networks and data analysis.

Hyperedge: A fundamental connection unit in a hypergraph that can link an arbitrary number of vertices, rather than being limited to two. Hyperedges are used to represent complex relationships or interactions among multiple vertices.

Vertex: A fundamental element in a graph or hypergraph, representing an entity or object. Each vertex may have a unique identifier and may carry associated attribute information.

Common vertex: A vertex that is jointly connected by multiple edges or hyperedges. In a graph or hypergraph, a vertex shared by two or more edges or hyperedges is referred to as a common vertex of those edges or hyperedges.

Topological information: Describing the connectivity relationships between nodes and edges in a network or graph, regardless of their geometric positions or distances. It focuses on how nodes are interconnected through edges, thereby reflecting the structural characteristics of the system.

Multiple factors contribute to redundant computation in hypergraph neural network inference.

First, due to the power-law distribution of hypergraphs, most computations involve a small set of common vertices and hyperedges, whose vertex and hyperedge features are repeatedly accessed. However, existing acceleration schemes typically perform independent computations for each vertex and hyperedge, without considering the global structure of the hypergraph or potential computational overlap between hyperedges. Particularly, for hyperedges with many vertices and frequent computations, feature overlap is more evident but underutilized, leading to redundant computation of vertex and hyperedge features in different computational contexts.

Secondly, when processing hyperedges with many vertices, the hyperedge aggregation operation (HA) frequently retrieves vertex features from the off-chip memory. This irregular memory access pattern increases memory access operations, reduces cache and memory bandwidth utilization, and further exacerbates redundant memory access and computation.

The consequences of redundant computation and irregular memory access include decreased computation efficiency and constrained system performance as computational capacity is underutilized. This directly affects the overall inference efficiency of hypergraph neural networks. Fundamentally, the failure to identify and exploit feature overlap among common vertices and hyperedges, combined with localized computation strategies and irregular memory access patterns in existing approaches, exacerbates this inefficiency.

In view of the shortcomings of the existing art, the present disclosure provides a method and system for hypergraph neural network inference. The present disclosure may further provide a hardware accelerator for hypergraph neural network inference. The present disclosure may further provide an electronic device configured to be installed with the hardware accelerator of the present disclosure or to operate the method for hypergraph neural network inference of the present disclosure. The present disclosure may further provide an electronic device configured to be installed individually or in combination with the hypergraph neural network inference system of the present disclosure.

### EMBODIMENT 1

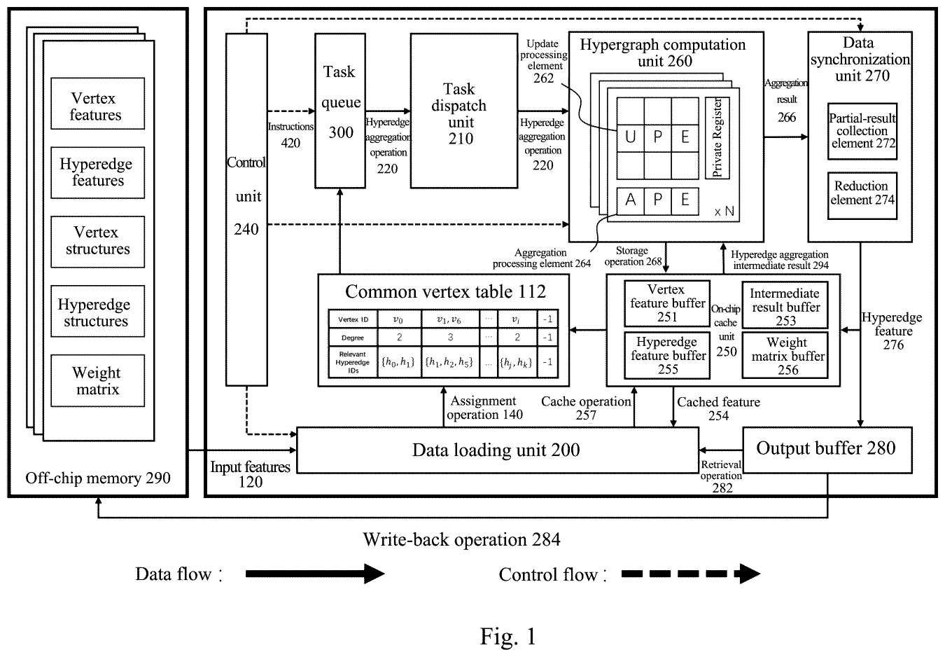

As shown in FIG. 1, the method and system framework of the present disclosure are exemplified using a hypergraph neural network inference system.

In FIG. 1, solid arrows denote data flow, and dashed arrows denote control flow. As shown in FIG. 1, the hypergraph neural network inference system may be a hardware accelerator. The hardware accelerator comprises a data loading unit 200, a task dispatch unit 210, a hypergraph computation unit 260, and an on-chip cache unit 250. Preferably, the data loading unit 200 may be physically implemented as a DMA controller (Direct Memory Access Controller) or a dedicated data transfer chip. The task dispatch unit 210 may be physically implemented as a control logic module in an ASIC (Application-Specific Integrated Circuit) or an FPGA (Field-Programmable Gate Array). The hypergraph computation unit 260 may be physically implemented as a GPU (Graphics Processing Unit), a TPU (Tensor Processing Unit), an NPU (Neural Processing Unit), or another DSA (Domain-Specific Architecture) processor. The on-chip cache unit 250 may be physically implemented as an SRAM (Static Random-Access Memory) array or other forms of high-speed cache memory.

Preferably, the hardware accelerator comprises a control unit 240. Preferably, the control unit 240 may be implemented as an embedded processor (e.g., ARM Cortex-M series) or a finite state machine, such as hardcoded logic circuits programmed into an FPGA-based hardware accelerator. The control unit 240 is configured to decode host instructions, generate control signals and coordinate data flow, and also connected to the data loading unit 200 and the task dispatch unit 210, respectively. The data loading unit 200 and the task dispatch unit 210 are connected to and in data communication with each other. The task dispatch unit 210 and the hypergraph computation unit 260 are connected to and in data communication with each other. The on-chip cache unit 250 is connected to and in data communication with the hypergraph computation unit 260 and the data loading unit 200, respectively. Preferably, both the data loading unit 200 and the hypergraph computation unit 260 are connected to and in data communication with the on-chip cache unit 250 for data buffering.

The core principle of the hypergraph neural network inference method disclosed herein is as follows:

Due to the power-law distribution of hypergraph structures, the majority of hyperedge and vertex computations involve only a small subset of vertices and hyperedges. As a result, certain vertices are included in multiple hyperedges and participate in repeated computations; these vertices are referred to as common vertices. A vertex with a higher degree (i.e., connected to more hyperedges) is more frequently involved in hyperedge computation. In common solutions where hyperedges are processed independently, this leads to extensive redundant computation and redundant memory access.

To address this issue, the present disclosure introduces a dynamic tracking mechanism. Specifically, during each iteration, the data loading unit 200 dynamically identifies common vertices connected to a large number of hyperedges and instructs the on-chip cache unit 250 to store their features and intermediate aggregation results. The task dispatch unit 210 assigns computation tasks to the hypergraph computation unit 260. In subsequent tasks involving these common vertices, the hypergraph computation unit 260 directly reuses the cached results from the on-chip cache unit 250, thereby avoiding repeated execution of the same computation logic. This approach not only eliminates redundant computation, memory access, and communication overhead, but also significantly improves the overall computation efficiency of hypergraph neural network inference. The disclosed method achieves strong performance across various hypergraph neural network models, including HGNN, HGNN+, UniGNN, and HGCN. An exemplary implementation based on the HGNN model is described below.

The hypergraph neural network inference method executed by the system disclosed herein is as follows.

Step S100 involves extracting topological information of vertices with the highest degree from the compressed hypergraph topological representation 100 using the data loading unit 200, identifying common vertices with the highest degree and hyperedges connected to them, and transmitting the common vertices and relevant hyperedges to the task dispatch unit 210 as a task queue 300.

Preferably, the control unit 240 controls the data loading unit 200 to, for a data loading task, perform initiation (by reading hypergraph data from an off-chip memory, with the specific loading logic implemented and controlled internally by the data loading unit 200) and completion (by receiving a load-complete signal from the data loading unit 200 and executing subsequent instructions from the host).

The data loading unit 200 detects common vertices in the hypergraph and initiates a breadth-first search (BFS) traversal along the hypergraph topology from these vertices. This traversal identifies common vertices with the highest degree and connected hyperedges. The topological information of the identified vertices and hyperedges is recorded for later use in orchestrating fine-grained aggregation tasks, which are then inserted into the task queue 300 for subsequent processing.

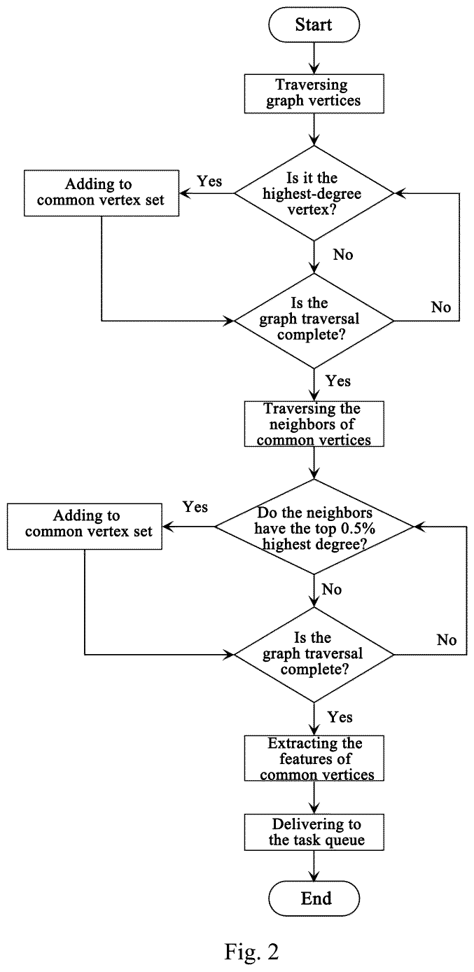

The data loading unit 200 loads data through the process shown in FIG. 2.

Upon initiation, the system traverses hypergraph vertices to determine whether each vertex is among the vertices with the highest degree.

If the current vertex is among the vertices with the highest degree, it is added to a common vertex set, followed by a determination of whether the hypergraph traversal is complete. If not, the traversal proceeds with the next vertex.

Upon completion of the hypergraph traversal, the neighbors of the common vertices are examined to determine whether any of them fall within the top 0.5% of vertices with the highest degree. If a neighbor satisfies this condition, it is also added to the common vertex set, and the traversal continues until all neighbors have been traversed.

Once the hypergraph traversal is complete, the features of the common vertices are extracted and delivered to the task queue 300, completing the process.

In Step S110, topological information of vertices with the highest degree is extracted from the compressed hypergraph topological representation 100 by the data loading unit 200, and a topology dependency queue 252 is formed. The queue 252 is subsequently cached in the on-chip cache unit 250 via a cache operation 257.

Specifically, the data loading unit 200 is configured to read the compressed hypergraph topological representation 100 from the off-chip memory 290 to which it is connected via a connection port. As illustrated in FIG. 1, the off-chip memory 290 preferably stores vertex features, hyperedge features, vertex structures, hyperedge structures, and a weight matrix.

Preferably, the topological representation is a method for describing spatial relationships among objects based on principles of topology. The hypergraph topological representation 100 denotes the topological relationships between vertices and hyperedges within the hypergraph.

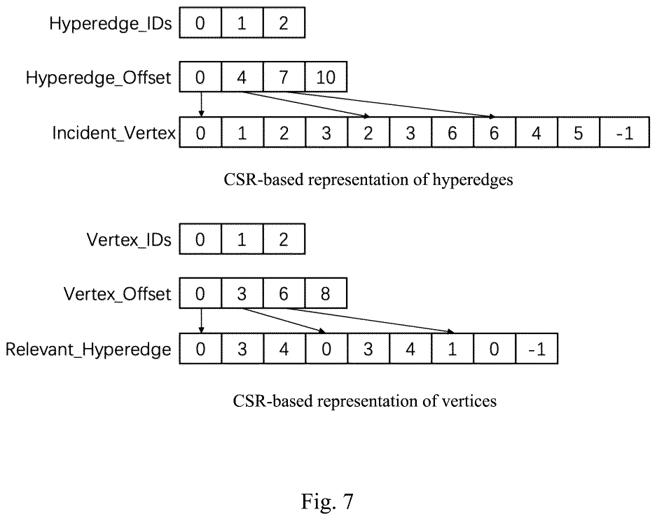

The data loading unit 200 is configured to support commonly used sparse matrix storage formats, including Coordinate List (COO), Compressed Sparse Column (CSC), and Compressed Sparse Row (CSR). For the sake of illustration, the CSR format is used as an example in the following description. A schematic diagram thereof is provided in FIG. 7.

In FIG. 7, the arrows indicate that the number i in the starting cell denotes the index of the destination cell within the corresponding array, representing the addressing process. In the CSR-based representation of hyperedges, the first row is a hyperedge identifier (Hyperedge_IDs) array, the second row is a hyperedge offset (Hyperedge_Offset) array, and the third row is an incident vertex (Incident_Vertex) array. The hyperedge offset specifies the starting location at which the incident vertices of a hyperedge are recorded. As a hyperedge may be connected to multiple vertices, all such vertices are referred to as incident vertices of the hyperedge.

In FIG. 7, within the CSR-based representation of vertices, the first row is a vertex identifier (Vertex_IDs) array, the second row is a vertex offset (Vertex_Offset) array, and the third row is a relevant hyperedge (Relevant_Hyperedge) array.

Upon acquiring the hypergraph topological representation 100, the data loading unit 200 performs the task of extracting topological information of the vertices with highest degree by executing five pipelined sub-steps. The input features 120 of the data loading unit 200 comprise all vertex identifiers (Vertex_IDs), namely, all elements of the first-row vertex identifier (Vertex_IDs) array in the CSR format.

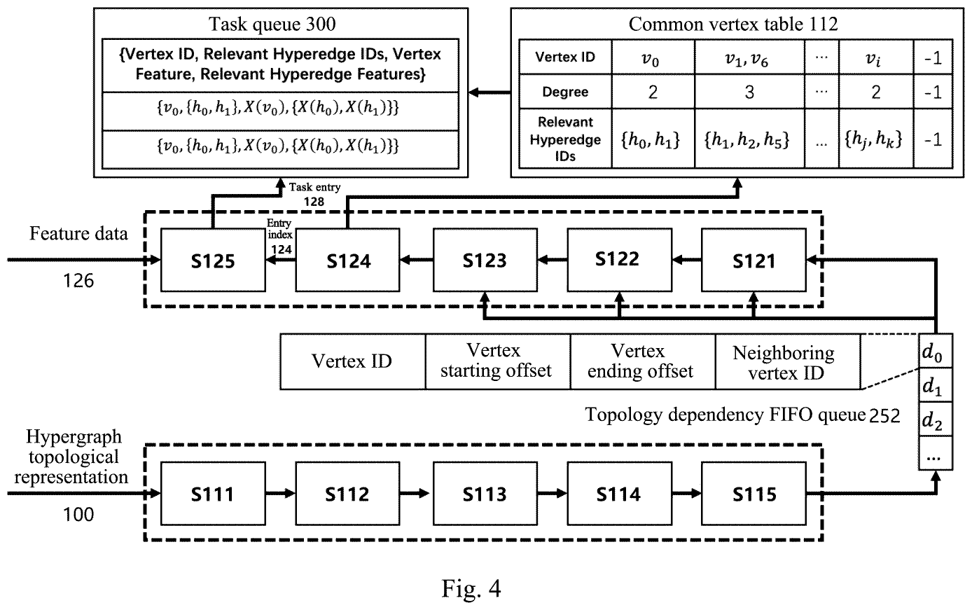

As shown in FIG. 4, the five sub-steps (S111-S115) executed by the data loading unit 200 are: extracting the root vertex, extracting the vertex offset, extracting the hyperedges, extracting the hyperedge offset, and extracting the neighboring vertices.

S111: Extract the root vertex.

Root vertex: For each input vertex identifier, the corresponding vertex serves as a root vertex from which its first-order neighbors are accessed.

This step maintains a marker array referred to as “visited”, having a length equal to the total number of vertices in the current hypergraph, with all entries initialized to “false”.

When a vertex v₀ (assumed its ID to be VID) is processed, visited[VID] is checked. If its value is false, it is set to “true”, indicating that the vertex has been processed, and the vertex is subsequently passed to Step S112. Otherwise, if visited[VID] is already “true”, further processing of the vertex is skipped because each vertex is required to be processed only once within the pipeline. Upon completion of the processing of all vertices, this pipeline sub-step is completed.

S112: Extract the vertex offset.

Based on the received hypergraph topological representation 100, the data loading unit 200 obtains the starting offset Vertex_Offset[VID] (denoted as startH₀) and the ending offset Vertex_Offset[VID+1] (denoted as endH₀) of the input vertex v₀ from the Vertex_Offset array. This information is subsequently transmitted to Step S113.

Although the degree of the current vertex may be calculated as endH₀-start H₀, such computation alone is insufficient to determine whether the vertex is among the vertices with the highest degree.

Accordingly, this step adopts the following processing strategy.

A maximum degree value is maintained, with its initial value set to 0. For each vertex processed, its degree (i.e., endH₀-startH₀) is compared against the current maximum degree value. If the degree is greater than or equal to the current maximum, the maximum value is updated, and the vertex ID, along with its starting offset startH₀ and ending offset end H₀, is output to Step S113. Otherwise, if the degree is less than the maximum, further processing of the vertex is skipped, as it is determined not to be among the vertices with the highest degree.

Although certain vertices output to the subsequent step may not be among the vertices with the highest degree, a First-In-First-Out (FIFO) mechanism implemented in the subsequent sub-steps ensures that vertices with higher degrees and their associated topological information are prioritized for storage. As such, this processing strategy does not compromise the overall design objective of the pipeline.

S113: Extract the hyperedges.

The data loading unit 200 is configured to extract all hyperedges (e.g., hⱼ) that include the vertex v₀ from the relevant hyperedge array. The relevant hyperedge array serves as a data structure for recording the set of vertices included in each hyperedge of the hypergraph.

Specifically, the execution steps are as follows: Based on the starting offset startH₀ and the ending offset endH₀ of the vertex v₀, obtained in Step S112, the data loading unit 200 accesses the relevant hyperedge array represented in the Compressed Sparse Row (CSR) format. A subarray from Relevant_Hyperedge[startH₀] to Relevant_Hyperedge[endH₀−1] is then output to Step S114. This subarray contains all hyperedge identifiers associated with the vertex Vo.

S114: Extract the hyperedge offset.

The data loading unit 200 acquires the starting offset and ending offset of hyperedge hⱼ, and transmits them to Step S115.

Specifically, for each element in the input subarray (namely, a hyperedge ID that includes vertex v₀, denoted as EID), the starting offset Hyperedge_Offset[EID] and the ending offset Hyperedge_Offset[EID+1] of the incident vertex set associated with this hyperedge are obtained from the Hyperedge_Offset array and output to Step S115.

S115: Extract the neighboring vertices.

The data loading unit 200 acquires the vertices included in hyperedge hⱼ from the incident vertex array, namely, vertex v₀.

Specifically, upon receiving the starting offset (denoted as startVⱼ) and the ending offset (denoted as endVⱼ) of the hyperedge hⱼ, the data loading unit 200 accesses the Incident_Vertex array in the CSR-based topological representation to obtain a subarray from Incident_Vertex[startVⱼ] to Incident_Vertex[endVⱼ−1]. This subarray represents the set of vertex identifiers included in hyperedge hⱼ, namely, all neighboring vertex identifiers of vertex v₀, collectively forming a neighboring vertex ID array.

As described previously, at the end of the pipeline, a data item is composed of four fields, including a vertex identifier obtained from Step S111, a starting offset (startH₀) and an ending offset (endH₀) obtained from Step S112, and a neighboring vertex ID array derived from Step S115. The data loading unit 200 subsequently transmits the data item to the end of the topology dependency queue 252, also referred to as the Topology Dependency & First-In-First-Out (TD FIFO).

S120: Identify the common vertices.

Rapid identification is performed to identify the common vertices with the highest degree within the current hypergraph.

Preferably, the common vertex table 112 is configured within the on-chip cache unit 250 of the data loading unit 200, and is used to store structured information corresponding to the identified common vertices with the highest degree.

Preferably, each entry of the structured information comprises three fields: vertex ID (Vertex ID); degree, namely the number of relevant hyperedges containing the vertex (Degree); and a list of relevant hyperedge IDs associated with the vertex (Relevant Hyperedge IDs).

As shown in FIG. 4, the identification of the common vertices is also performed through pipeline steps S121 to S125 of the data loading unit 200.

S121: Extract the root vertex.

A data item (namely, the data item do corresponding to the vertex v₀) is extracted from the head of the topology dependency queue 252, and the vertex ID field of the data item d₀ is retrieved as the ID of the root vertex to be extracted.

S122: Extract the neighboring vertices.

This step is performed in parallel with Step S121.

The “Neighbor ID” field is extracted from the data item do. This field is a list containing identifiers of all vertices adjacent to the vertex v₀.

S123: Extract the neighboring vertex offset.

This step is also performed in parallel with Step S121.

For each obtained neighbor ID, a pair of starting and ending offsets is acquired from the vertex offset array, forming a set {(startH₀, endH₀), . . . , (startHₙ₋₁, endHₙ₋₁)}, where n represents the number of neighbors.

S124: Detect data.

The degree of the root vertex is determined based on the start H₀ and endH₀ fields of the data item do.

The degree of each neighbor of the root vertex is determined using the corresponding starting and ending offsets of the neighboring vertices.

The procedure for obtaining the degrees of the root vertex and its neighbors is similar to that in Step S113, except that the final step involves calculating the length of the subarray in the relevant hyperedge array as the vertex degree, rather than copying the subarray itself from the array of associated hyperedges (Relevant_Hyperedge). Assuming that the root vertex has n neighboring vertices, the degree of the root vertex, deg_root, and a neighboring vertex degree list, {deg₀, . . . , degₙ₋₁}, are determined.

The list of vertex degrees {degᵣₒₒₜ, deg₀, . . . , degₙ₋₁} is traversed. For each vertex degree deg and its corresponding vertex v₀, every entry in the common vertex table 112 is traversed and processed based on specific conditions until the traversal is complete.

As illustrated in FIG. 1, if an empty entry is encountered, an assignment operation 140 is executed. The “Vertex ID” field is set to the corresponding vertex ID, and the “Degree” field is set to deg. The “Relevant Hyperedge IDs” field is populated with all hyperedge IDs associated with vertex v₀. These hyperedge IDs are derived by applying the same computation method as in Step S113, using the startH₀ and endH₀ fields from the data item do obtained in Step S121 (for the root vertex), or the two offset values obtained in Step S123 (for a neighbor of the root vertex).

If a non-empty entry is encountered, the vertex degree deg is compared with the “Degree” field of the entry. When deg is greater than the value of the “Degree” field, the entry is treated as empty and updated accordingly. When deg is less than the stored degree, the traversal proceeds to the next entry. Each time an entry in the common vertex table 112 is updated, the index 124 of the updated entry is output to the subsequent step to trigger corresponding execution logic. This step ensures that vertices with degrees greater than those already stored are recorded in the common vertex table 112.

S125: Extract feature data 126.

Immediately, the updated entry index 124 of the common vertex table 112 is retrieved. The corresponding entry is then accessed to extract the feature data 126 associated with the vertex ID (Vertex ID). The feature data 126 comprises a vertex feature (Vertex Feature), a list of relevant hyperedge IDs (Relevant Hyperedge IDs), and the corresponding relevant hyperedge features 276 (Relevant Hyperedge Features). The four fields, namely Vertex ID, Vertex Feature, Relevant Hyperedge IDs and Relevant Hyperedge Features, are assembled into a task entry 128 and transmitted to the task queue 300.

During the extraction of the feature data 126, a similarity-based hierarchical storage structure and caching strategy is adopted by the hardware accelerator of the present disclosure to optimize data locality and minimize the communication overhead with the off-chip memory 290. Vertex features with higher total degrees are preferentially cached into a vertex feature buffer 251, which is a specific region within the on-chip cache unit 250 of the hardware accelerator.

The data loading unit 200 first accesses the cached feature 254. In response to a cache miss, the input features 120 are retrieved from the off-chip memory 290. In the present disclosure, the total vertex degree is defined as the sum of the degrees of all hyperedges that include the vertex. The degree of each hyperedge is calculated in a manner similar to that described in Step S115, except that the degree is obtained by directly computing the length of the subarray in the Incident_Vertex array, rather than by copying the subarray.

Specifically, a threshold TD is set to define the minimum total vertex degree required for the vertex features to be cached into the vertex feature buffer 251.

Initially, the threshold TD is set to 0 and dynamically adjusted during runtime. Upon loading vertex features from the off-chip memory 290, the data loading unit 200 evaluates whether the total vertex degree of the corresponding vertex meets the threshold TD. If so, the vertex feature is cached into the vertex feature buffer 251. When the vertex feature buffer 251 has insufficient storage capacity, the data loading unit 200 evicts vertex features whose total vertex degrees are equal to the current threshold TD, until sufficient space is released for newly cached vertex features. The threshold TD is subsequently updated to the total vertex degree of the most recently cached vertex. By dynamically adjusting the caching policy based on the total vertex degrees, the hardware accelerator significantly reduces access overhead to the off-chip memory 290, thereby enhancing the overall efficiency and performance of the hypergraph neural network inference process.

S200: In response to the instruction 420 from the control unit 240 for task dispatch, the task dispatch unit 210 dispatches the task to the hypergraph computation unit 260.

The hypergraph computation unit 260 initiates redundancy-aware asynchronous aggregation.

S300: The hypergraph computation unit 260 triggers the hyperedge aggregation operation 220 for each hyperedge in parallel based on the common vertices from the common vertex table 112 included in the task queue 300.

The hypergraph computation unit 260 performs the hyperedge aggregation operation 220 for each hyperedge. The intermediate results generated during the aggregation are temporarily stored in the intermediate result buffer 253 of the on-chip cache unit 250 via a storage operation 268. During the sequential execution of hyperedge aggregation operations 220 based on the storage order of hyperedges in the hypergraph topological representation 100, the hyperedge aggregation intermediate results (also referred to as intermediate aggregation results) 294 of the common vertices from the common vertex table 112 are reused, thereby obtaining the final aggregation result for each hyperedge.

The hypergraph computation unit 260 is configured to efficiently perform hybrid computations for hyperedge and vertex operations.

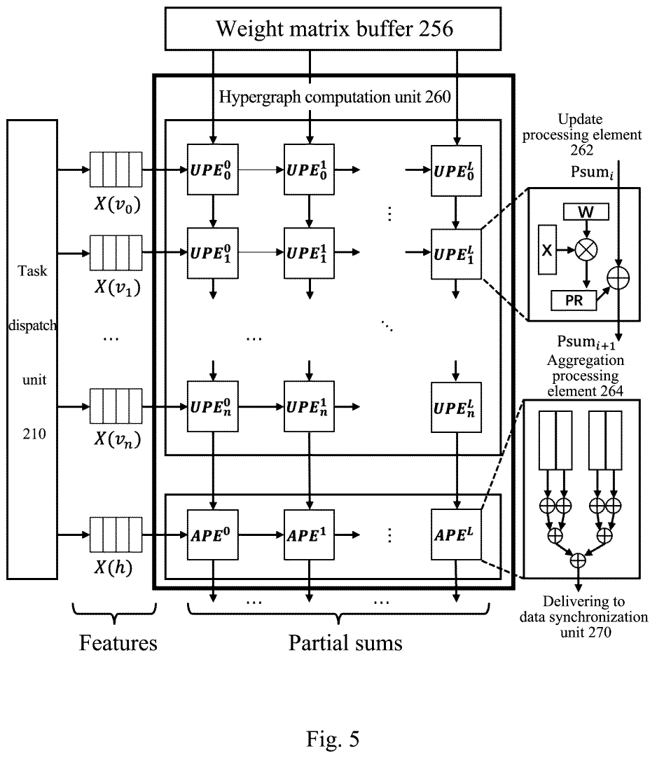

As shown in FIG. 5, the hypergraph computation unit 260 comprises an update processing element (UPE) 262 and an aggregation processing element (APE) 264.

The UPE 262 uses row-wise matrix multiplication to support operations for feature projection (FP) and vertex update (VU). The APE 264 is configured to perform operations in stages for hyperedge aggregation (HA) and vertex aggregation (VA). Partial sums (Psum) generated during FP and HA computations may be stored in private registers (PRs) within the update processing element 262, thereby improving matrix computation efficiency.

The hyperedge aggregation (HA) operation 220 is configured to compute updated hyperedge features by applying an aggregation function (e.g., summation or averaging) to the features of the incident vertices. The vertex aggregation (VA) operation refers to computing updated vertex features by aggregating the features of all relevant hyperedges that include the vertex. The VA operation is dependent on the results generated by the HA operation 220.

The relationship among the hypergraph update, the HA operation 220, and the VA operation is mathematically formulated as follows:

$${h}_{e}^{l} = HA ( FP ( {x}_{j}^{l - 1} \vert {v}_{j} ∈ e ) ) .$$

$${X}_{i}^{l} = σ ( VU ( VA ( {h}_{e}^{l} \vert e ∈ N ( {v}_{i} ) ) ) ) .$$

Wherein, xᵢ denotes the feature of vertex vᵢ, and hₑ represents the feature of hyperedge e. In addition to the HA operation 220 and the VA operation, FP represents the feature projection operation, in which the original feature information is projected to a target dimension by multiplying the feature xⱼ of a vertex vⱼ with a trainable projection matrix θ. VU denotes the vertex update operation that involves multiplying a trainable weight matrix W with the result of VA to generate an updated vertex feature. The symbol σ denotes an activation function (e.g., ReLU).

The FP operation and the VU operation require trainable weight matrices in the hypergraph neural network to perform matrix multiplication with the feature matrix. The weight matrix buffer 256 of the present disclosure is used to receive and temporarily store the weight matrices required for matrix computation.

As shown in FIG. 1, the UPE 262 of the hypergraph computation unit 260 transmits the partial aggregation results 266 of hyperedges and vertices to the data synchronization unit 270 to compute the final features of each vertex. Concurrently, the aggregation processing element 264 stores the hyperedge aggregation intermediate results 294, the corresponding hyperedge IDs, and the number of participating vertices into the intermediate result buffer 253 via a storage operation 268, thereby enabling timely triggering of the reduction operation.

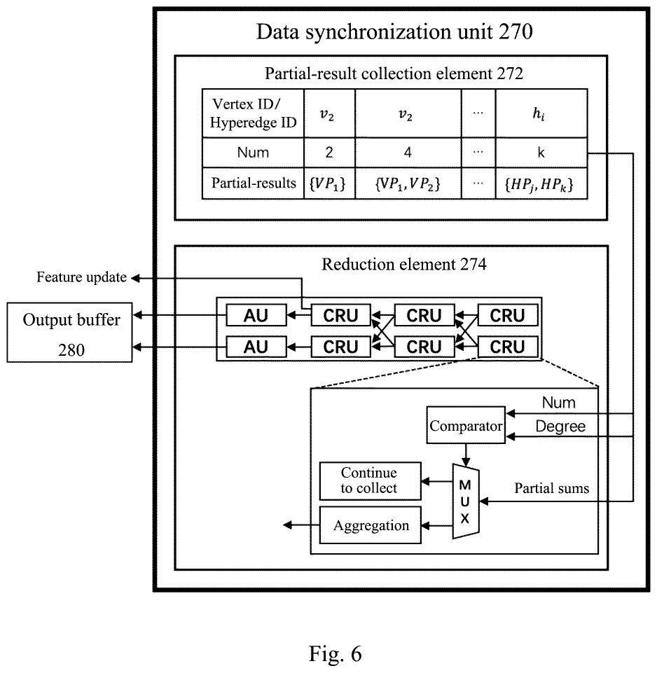

As shown in FIG. 1 and FIG. 6, the data synchronization unit 270 is used for reduction and activation operations and includes a partial-result collection element 272 and a reduction element 274. The partial-result collection element 272 and the reduction element 274 work cooperatively to manage and synchronize the partial results generated by the computations associated with hyperedges and vertices. These computations are initiated by common vertices and remaining vertices. The partial-result collection element 272 may record the partial results of aggregation operations, while tracking the hyperedge ID or vertex ID associated with the aggregation operation and the count of vertices/hyperedges involved in the partial aggregation. The reduction element 274 includes a comparison reduction unit (CRU) and an activation unit (AU), which are respectively used to perform the actual reduction operation of the partial results and to support the necessary nonlinear transformation of the processed data. After completing these transformations, the resulting output is sent to the output buffer 280 for immediate retrieval operation 282 or final storage to the off-chip memory 290 through a write-back operation 284.

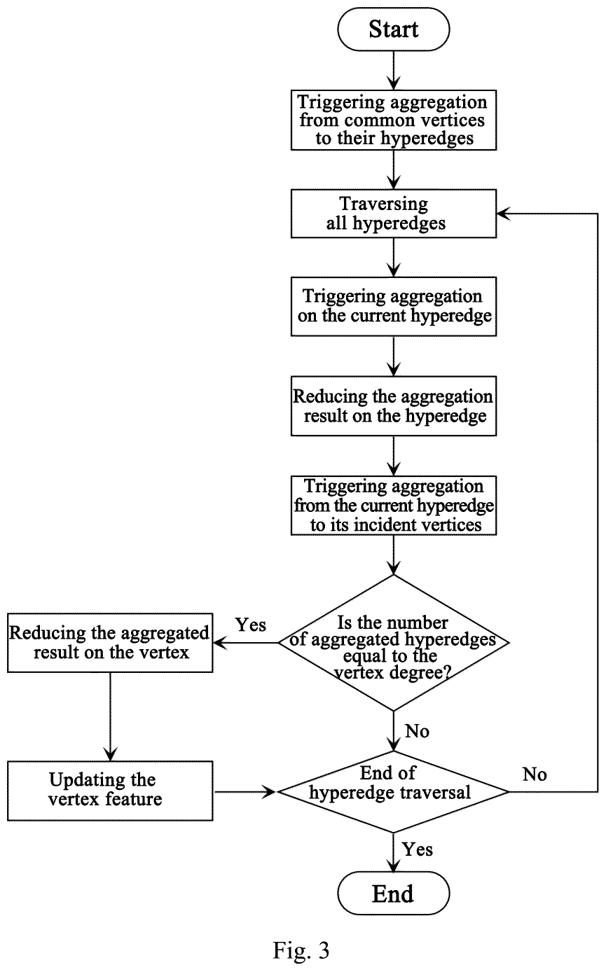

The aggregation computation procedure is illustrated in FIG. 3.

The process begins with triggering the vertex aggregation from the common vertices to their corresponding hyperedges. Then, all hyperedges are traversed. Each hyperedge is triggered to perform aggregation, and the aggregation result 266 on each hyperedge is reduced. Subsequently, the vertex aggregation is triggered from the current hyperedge to its incident vertices. It is then determined whether the number of aggregated hyperedges equals the vertex degree. If they are not equal (“NO”), it is determined whether the hyperedge traversal has completed. If completed, the process ends. If not completed (“NO”), all hyperedges are traversed again.

If the number of aggregated hyperedges equals the vertex degree, the aggregated result 266 of the vertex is reduced, and the vertex feature is updated. It is determined again whether the hyperedge traversal has completed.

Specifically, the UPE 262 triggers the HA operations 220 on all hyperedges in the order defined by the hypergraph topological representation 100 (some intermediate results may be cached in Step S210). During this process, the data synchronization unit 270 performs reduction based on the hyperedge IDs and vertex count values recorded by the partial-result collection element 272. When the number of vertices completing the HA operation 220 matches the degree of the corresponding hyperedge, indicating that all partial results have been collected, the reduction element 274 is instructed by the data synchronization unit 270 to perform the reduction operation.

As illustrated in FIG. 6, each reduction element 274 comprises a comparator to verify whether the partial-result count values (Num and Degree) meet the degree condition of the hyperedge or vertex. The verification result satisfying the condition triggers a multiplexer (MUX) to select the appropriate HA operation 220, and the partial sum is sent to the reduction element 274 for computation. The resulting hyperedge feature 276 is stored in the hyperedge feature buffer 255 to be used in the subsequent VA stage.

When a hyperedge completes its feature update, the aggregation operation of the vertices included in that hyperedge is triggered in parallel. During this process, the partial-result collection element 272 continues to collect partial results generated by the aggregation and records the corresponding vertex IDs and the number of hyperedges involved in the aggregation. Based on the vertex IDs and the hyperedge count values recorded by the partial-result collection element 272, the data synchronization unit 270 triggers the reduction operation and stores the resulting vertex features in the output buffer 280. The above operations are repeatedly performed until the features of all vertices are updated.

The hardware accelerator and method of the present disclosure provide the following technical advantages:
(1) Rapid hypergraph neural network inference: The present disclosure introduces topology-driven data loading and redundancy-aware asynchronous aggregation to cache and reuse computation results of common vertices, significantly reducing redundant computation, memory access, and off-chip communication (reducing total memory access volume and I/O operations). This effectively improves the throughput of hypergraph neural network inference.
(2) High computation efficiency and high processor utilization: By leveraging topology-driven data loading, a similarity-based hierarchical storage architecture, and a caching strategy, the present disclosure efficiently caches intermediate results of common vertices. This minimizes off-chip memory access and redundant data transfer overhead, thereby improving processor resource utilization.

It should be noted that the above-mentioned embodiments are exemplary. Those skilled in the art, inspired by the present disclosure, may devise various solutions within the scope and protection of the present disclosure. Furthermore, those skilled in the art will recognize that the specification and accompanying drawings provided herein are illustrative and form no limitation to any of the appended claims. The protection scope of the present application is defined by the appended claims and their equivalents. The specification provided herein encompasses multiple inventive concepts, with terms like “preferably” or “according to a preferred embodiment” indicating distinct concepts in respective paragraphs. The applicant reserves the right to file divisional applications for each inventive concept.

What is claimed is:

1. A method for hypergraph neural network inference, characterized by comprising:
extracting topological information of vertices with the highest degree from a compressed hypergraph topological representation, identifying common vertices with the highest degree and their connected hyperedges, and transmitting them to a task queue;
based on common vertices from the task queue and a common vertex table, triggering hyperedge aggregation operations on each hyperedge in parallel; and
performing the hyperedge aggregation operation for each hyperedge, temporarily storing intermediate aggregation results in an intermediate result buffer of an on-chip cache unit, and, during sequential execution of the hyperedge aggregation operations based on a storage order of hyperedges in the hypergraph topology, reusing the intermediate aggregation results of the common vertices from the common vertex table, thereby obtaining a final aggregation result for each hyperedge.

2. The method of claim 1, wherein the step of extracting topological information of vertices with the highest degree comprises:
reading the compressed hypergraph topological representation;
extracting root vertices, vertex offsets, hyperedges, hyperedge offsets, and neighboring vertices; and
forming a data item comprising four fields: vertex ID, starting and ending offset within the vertex offsets, and ID array of the neighboring vertices.

3. The method of claim 2, wherein the step of identifying common vertices with the highest degree and their connected hyperedges comprises:
extracting root vertices, neighboring vertices, and neighboring vertex offsets;
detecting the degree of each neighboring vertex;
traversing a neighboring vertex degree list; if an empty entry is encountered, performing an assignment operation; if a non-empty entry is encountered, comparing the degree of the current vertex with the field of that entry; if the current vertex's degree is greater, treating the entry as empty and performing the assignment operation; if the degree is less, continuing the traversal, thereby identifying vertices with higher degrees than previously known and recording them in the common vertex table.

4. The method of claim 3, wherein the step of identifying common vertices with the highest degree and their connected hyperedges further comprises:
acquiring an updated entry index of the common vertex table in real time, retrieving that entry, and extracting the corresponding vertex ID and its associated vertex features and hyperedge features; and
assembling the vertex ID, vertex features, and hyperedge features into a task entry, and transmitting the task entry to the task queue.

5. The method of claim 4, further comprising:
transmitting partial aggregation results of hyperedges and vertices to a data synchronization unit to obtain final features of each vertex; and
simultaneously storing the intermediate aggregation results of hyperedges, the corresponding hyperedge IDs, and the number of participating vertices in the intermediate result buffer, thereby ensuring that reduction operations are triggered at the appropriate time.

6. The method of claim 5, wherein a data loading unit
extracts topological information of vertices with the highest degree from a compressed hypergraph topological representation;
identifies common vertices with the highest degree and their connected hyperedges; and
transmits the common vertices and hyperedges in the form of a task queue to a task dispatch unit.

7. The method of claim 6, wherein a control unit controls the data loading unit to initiate and terminate data loading tasks.

8. The method of claim 7, wherein the data loading unit detects common vertices in the hypergraph and, using these vertices as starting points, traverses other vertices along the hypergraph topology in a breadth-first search manner.

9. The method of claim 8, wherein the data loading process of the data loading unit comprises:
after initiation, traversing graph vertices and determining whether each vertex has the highest degree;
if so, adding it to a common vertex set and determining whether the graph traversal is complete;
if not, directly determining whether the graph traversal is complete;
if the graph traversal is not complete, repeating the determination for the next vertex.

10. The method of claim 9, further comprising:
if the graph traversal is complete, traversing the neighbors of the common vertices to determine whether any neighbor ranks among the top 0.5% in vertex degree;
if so, adding them to the common vertex set and rechecking if the traversal is complete;
if not, continuing the determination process for the remaining neighbors.

11. A system for hypergraph neural network inference, characterized in that the system comprises:
a data loading unit, configured to extract topological information of vertices with the highest degree from a compressed hypergraph topological representation, identify common vertices with the highest degree and their connected hyperedges, and transmit the common vertices and hyperedges to a task dispatch unit in the form of a task queue;
the task dispatch unit, configured to dispatch tasks to a hypergraph computation unit in response to a task dispatch instruction issued by a control unit;
the hypergraph computation unit, configured to, based on the common vertices from the task queue and a common vertex table, trigger hyperedge aggregation operations on each hyperedge in parallel, perform such aggregation operations, and temporarily store intermediate aggregation results in an intermediate result buffer of an on-chip cache unit, and, during sequential execution of the hyperedge aggregation operations based on a storage order of hyperedges in the hypergraph topology, reuse the intermediate aggregation results of the common vertices from the common vertex table, thereby obtaining a final aggregation result for each hyperedge; and
the on-chip cache unit, configured to cache data generated by the hypergraph computation unit during the aggregation process.

12. The system of claim 11, wherein the interaction between the data loading unit and the on-chip cache unit comprises:
accessing cached features, and retrieving input features from off-chip memory in response to a cache miss on a required feature;
when loading vertex features from the off-chip memory, evaluating whether the total degree of the vertex meets a threshold TD;
if so, caching the vertex features to a vertex feature buffer;
when there is insufficient space in the vertex feature buffer, evicting vertex features whose total degree equals the current threshold TD until enough space is freed for the new vertex features; and
subsequently, updating the threshold TD based on the total degree of the most recently cached vertex.

13. The system of claim 12, wherein the step of the data loading unit identifying common vertices with the highest degree and their connected hyperedges comprises:
extracting root vertices, neighboring vertices, and neighboring vertex offsets;
detecting the degree of each neighboring vertex;
traversing a neighboring vertex degree list; if an empty entry is encountered, performing an assignment operation; if a non-empty entry is encountered, comparing the degree of the current vertex with the field of that entry; if the current vertex's degree is greater, treating the entry as empty and performing the assignment operation; if the degree is less, continuing the traversal, thereby identifying vertices with higher degrees than previously known and recording them in the common vertex table.

14. The system of claim 13, wherein the hypergraph computation unit comprises:
an update processing element, configured to perform feature mapping and vertex update operations based on row-wise matrix multiplication; and
an aggregation processing element, configured to perform aggregation operations, including hyperedge aggregation and vertex aggregation.

15. The system of claim 14, further comprising a data synchronization unit configured to perform reduction operations and activation function operations,
wherein the data synchronization unit comprises:
a partial-result collection element, configured to record partial results of aggregation operations, and to track corresponding hyperedge IDs or vertex IDs, as well as the number of vertices or hyperedges involved in each partial aggregation; and
a reduction element, configured to perform the reduction operation when it is detected that the number of vertices that have completed the hyperedge aggregation operation equals the degree of the corresponding hyperedge, thereby indicating that all partial results from the vertices have been collected.

16. The system of claim 15, wherein the data loading unit is configured to extract topological information of vertices with the highest degree from a compressed hypergraph topological representation, identify common vertices with the highest degree and their connected hyperedges, and transmit them to the task dispatch unit as a task queue.

17. The system of claim 16, wherein the control unit is configured to control the data loading unit to initiate and terminate data loading tasks.

18. The system of claim 17, wherein the data loading unit is configured to detect common vertices in the hypergraph and, using these vertices as starting points, traverse other vertices along the hypergraph topology in a breadth-first search manner.

19. The system of claim 18, wherein the data loading process of the data loading unit comprises:
after initiation, traversing graph vertices to determine whether each vertex has the highest degree;
if so, adding the vertex to a common vertex set and checking whether the graph traversal is complete;
if not, directly checking whether the graph traversal is complete;
if the traversal is not complete, repeating the above steps until completion.

20. The system of claim 19, wherein upon completion of the graph traversal, the neighbors of the common vertices are traversed to determine whether any neighbor ranks among the top 0.5% in vertex degree;
if so, the neighbor is added to the common vertex set, followed by a re-evaluation of traversal completeness;
if not, the determination is repeated for the next neighbor.
